(19) United States
(12) Patent Application Publication
(10) Pub. No.: US 2007/0124589 A1
(43) Pub. Date: May 31, 2007

(54) Systems and methods for the protection of non-encrypted biometric data

(76) Inventors: Ronald D. Sutton, Orlando, FL (US); Son Thanh Ngo, Orlando, FL (US)

Correspondence Address: WELSH & KATZ, LTD, 120 S RIVERSIDE PLAZA, 22ND FLOOR, CHICAGO, IL, 60606, US

(21) Appl. No.: 11/291,046

(22) Filed: Nov. 30, 2005

(51) Int. Cl. H04L 9/00

(52) U.S. Cl. 713/169; 713/170

(57) ABSTRACT

Data can be stored in unencrypted form in an electronic device such as a smart card. The data will only be made available in response to successful execution of a mutual authentication process. Subsequently, when mutual authentication has been successfully completed, the data is made available to the host.

### FIELD OF THE INVENTION

The invention pertains to systems and methods to carry out mutual authentication. More particularly, the invention pertains to such systems and methods which block access to selected data until mutual authentication has been successfully completed.

### BACKGROUND OF THE INVENTION

The use of various types of transaction initiating and/or facilitating cards has become widespread. A variety of types of cards and configurations are known.

One type of card, known as a “smartcard”, incorporates a limited capability programmable processor, memory and control program into a card of a size comparable to a credit card.

Because of size limitations, smart card processors tend to be implemented with relative simple microprocessors or controllers. Since biometric data which might be stored on such cards can be substantially extensive, requiring for example up to 12K bytes or more of storage, decryption of the data with such less capable processors can require unacceptably long periods of time.

There thus exists a need for systems and methods which prevent unauthorized access to such stored biometric data without imposing a need to encrypt the data. Preferably the stored biometric data can be adequately protected while at the same time reducing the amount of processing required.

### BRIEF DESCRIPTION OF THE DRAWING

FIG. 1 is a block diagram of a system which embodies the invention;

FIG. 2 is an exemplary activity diagram in accordance with the present invention;

FIG. 3 is a host flow diagram;

FIG. 4 is a smart card flow diagram;

FIG. 5 is a sequence diagram illustrating additional details of a method in accordance with the invention;

FIG. 6 illustrates additional details of a processing method in accordance with the invention; and

FIG. 7 illustrates method steps in accordance with the invention which includes creating a session key.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one aspect of the invention, the biometric data stored in memory of an electronic device, for example a smart card, can be stored in an unencrypted form. The data can only be externally accessed after a mutual authentication process has been successfully completed. Only subsequently does a processing unit of the device or smart card permit the biometric data to be read. Hence, protection is achieved by denying access to other hosts or systems which do not possess the appropriate authorizing key.

In one system and method which embody the invention a smart card can be inserted into a reader or a terminal. The card can be a contact or a non-contact type all without limitation.

In yet another aspect of the invention, the host which is seeking access to the data initiates an internal authentication process with the smart card. In this regard, the host generates a multi-byte random number which in part includes a target number. The random number is transmitted to the smart card with the request that the smart card carry out internal authentication.

In a disclosed embodiment of the invention, the process utilizes two static keys. The first key is used by the smart card to extract the target multi-byte number from the larger multi-byte random number received from the host. The smart card processes the internal authentication request by in part extracting the target random number, generating its own random number and generating a card cryptogram which are returned to the host's processor.

The host's processor extracts a card random number and card cryptogram from mixed multi-byte data received from the smart card. The random number received from the card as well as the card cryptogram are extracted using one of the static keys. The host calculates a cryptogram and compares it to the received card cryptogram. If the two cryptograms match, an external authentication process can be initiated.

In one aspect of the invention, an external authentication command is received by the smart card from the host. This command includes a host cryptogram. The smart card calculates the cryptogram using the second static key and compares it with the host cryptogram. If the two cryptograms match a corresponding status report is transmitted to the host. Hence the authentication process has been successfully completed, the smart card's processor permits access to the stored biometric data for use by the host.

In yet another aspect of the invention, a second static key can be used by both the host and the smart card processor to generate a session key. Session keys are calculated from the same derived data from the host and card random numbers as well as the identical second static key. The session key is thus the same for both the host and the smart card. The session key is recalculated for each mutual authentication process and is different each time.

In a further aspect of the invention, an internal authentication process can be initiated by the host by forwarding selected multi-byte random number, for example 16 bytes. A subset, for example, 8 bytes of data corresponds to a target number. The recipient unit which is to carry out the authentication process, uses a first static key to extract the target multi-byte random number. Other data can be discarded. The unit generates its own random number. Both the locally generated random number and the second static key can then be used to generate a session key. A local unit cryptogram can also be established. The first static key can then be used to rearrange the card random number with the card cryptogram prior to forwarding it to the host. The host upon receipt of the data, uses its random number and received card random number to determine its session key and cryptogram. The card cryptogram is compared by the host with this calculated cryptogram. A match indicates that the card is authentic and the host can proceed.

In a disclosed embodiment, the host cryptogram is then calculated. The calculated host cryptogram is mixed with a random number prior to forwarding them to the unit along with a command to carryout an external authentication process. The receiving unit extracts the host cryptogram from the received data using the first static key. The receiving unit calculates its own version of a cryptogram using the same process previously carried out by the host. If the two cryptograms match the external authentication process has been successfully completed. The unit can return a “no error” indicator or status to the host. It can then gain access to the stored data.

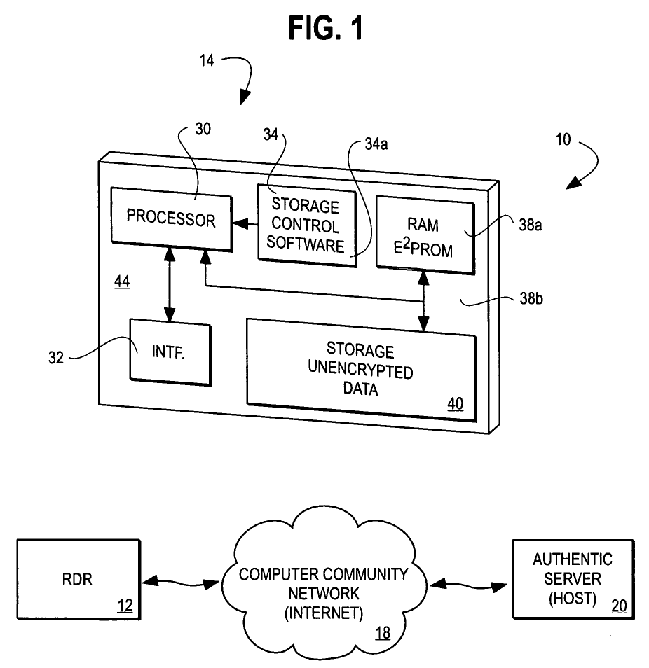

FIG. 1 illustrates a system 10 in accordance with the invention. System 10 incorporates a reader 12 of the type usable with smart cards, an exemplary one of which is illustrated as card 14. The reader 12 can be contact or a non-contact type all without limitation.

Reader 12 which can be part of a local computer system, can communicate via one or more networks 18, for example an internet, to an authentication server or host 20. As those of skill in the art will understand, cards 14 are particularly useful in connection with initiating, facilitating or carrying out various types of transactions. Types of transactions include authorizing access to a region or authorizing payment for goods or services.

Exemplary smart card 14 can incorporate a programmable processor 30 and interface circuitry 32 to enable the processor 30 to communicate with an external environment. Storage 34 in the form of read-only memory, for example, can be provided to store control software 34a to be executed by the processor 30. The control software 34a can, in conjunction with processor 30, carryout subsequently described authentication processing.

Card 14 can also incorporate random access memory 38a and electrically erasable programmable memory 38b usable by the control software 34a as would be understood by those of skill in the art. Finally, the card 14 can incorporate storage for unencrypted data 40. The unencrypted data 40 can be stored in any convenient format. Neither the type of data nor the way in which it is stored on card 14 are limitations of present invention.

It is of particularly advantageous aspect of the present invention that the data can be stored in unencrypted form thereby minimizing the degree and extent of processing required by the programmable processor 30. While large quantities of data could be stored on card 14 its unencrypted nature makes it possible under appropriate circumstances, to make the data available with both minimal response times and with limited capability processors. This contributes to the convenience of using the card 14 as well as making it possible to reduce its size.

Those of skill in the art will understand that the card 14 can incorporate a body portion 44 which carries at least the above described elements including processor 30, interface 32, storage 34, control software 34a, processing memory 38 and unencrypted data 40. While the body portion 44 can be configured with a form factor such as that of a credit or debit card, it will be understood that neither shape nor the dimensions of the body portion 44 represent limitations of the present invention.

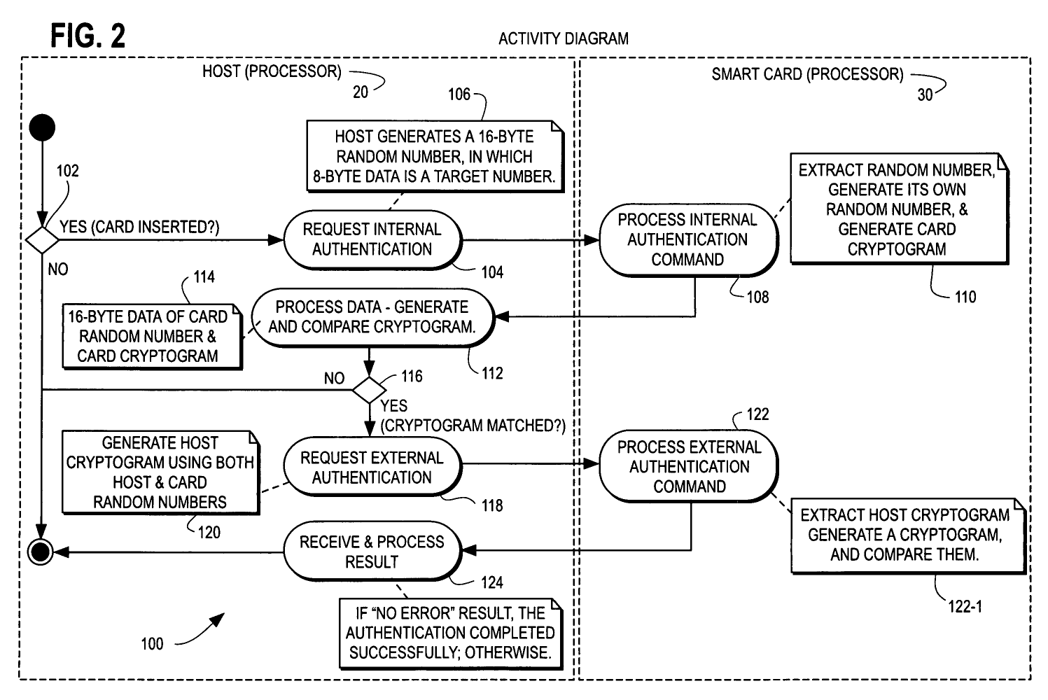

FIGS. 2-7 illustrate various aspects of the mutual authentication processing which can be carried by card 14 as well as host 20 in arriving at a determination as to whether or not the encrypted data 40 should be made available to the host 20.

FIG. 2 illustrates process 100, an overall view of processing by the host 20 and the smart card 14. In a threshold step 102 a determination is made at processor 20 that a card is available to be read at the reader 12.

The presence of a card, such as the card 14 indicates a request for service which ultimately requires access to the data 40 stored on the card 14. In a step 104 the host 20 forwards a request for internal authentication, which incorporates a multi-byte random number which incorporates a target number, see note 106. Card processor 30 in turn processes the internal authentication command, a step 108 which includes extracting the target multi-byte number from the larger random number received from the host. The smart card processor 30 then generates its own random number and card cryptogram, see note 110.

The processor 30 mixes the random number and cryptogram using the first, predetermined, static key. This result is then forwarded to the host processor 20 which extracts the random number and cryptogram using the same static key step 112, see note 114. As part of the processing 12, the processor 20 calculates a cryptogram and compares it to the received cryptogram. Where the cryptograms match, step 116 the host process 20 then requests external authentication step 118.

The request for external authentication includes generating a host cryptogram by using both host and card random numbers using the second static key, see note 120. In a step 122 the smart card processor 30 receives the host cryptogram and calculates a cryptogram using the second static key which it can then compare to the received cryptogram, see note 122-1. Results of the comparison can be transmitted to the host processor 20, step 124. Where the two cryptograms match, the authentication process has been completed successfully and the data 40 carried on card 14 can be made available to the host processor 20.

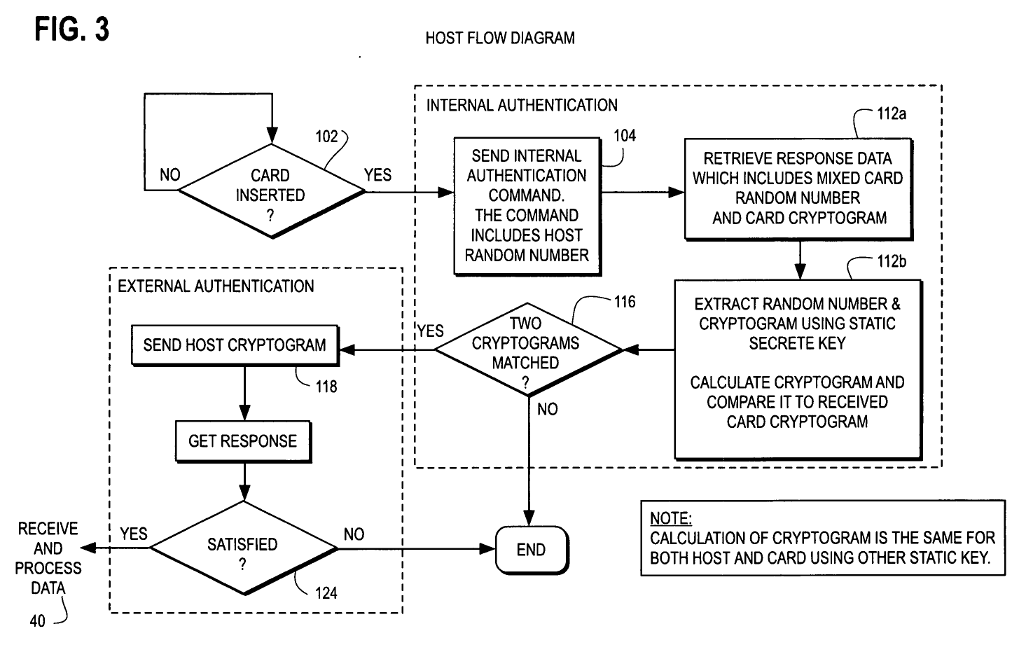

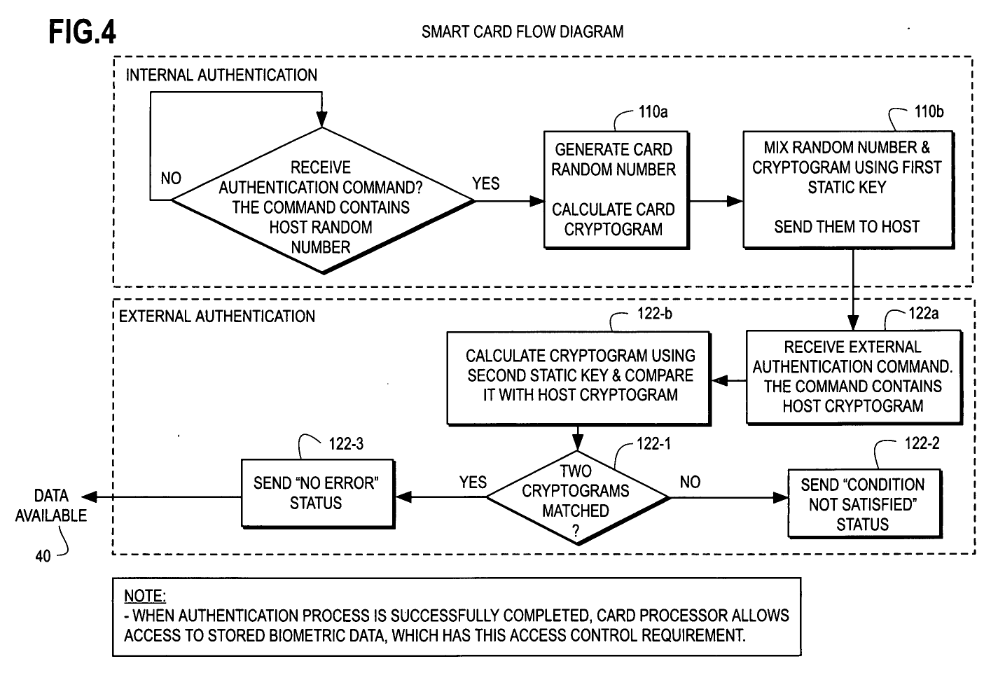

FIGS. 3 and 4 are flow diagrams of the host processing and smart card processing illustrate additional details of the process 100. Steps corresponding to the steps of FIG. 2 are assigned the same identification numerals. Relative to FIG. 4, when the smart card processor 30 receives the authentication command, it generates the card random number and card cryptogram, step 110a. The random number and cryptogram; are mixed using the first static key step 110b. They are then sent back to the host.

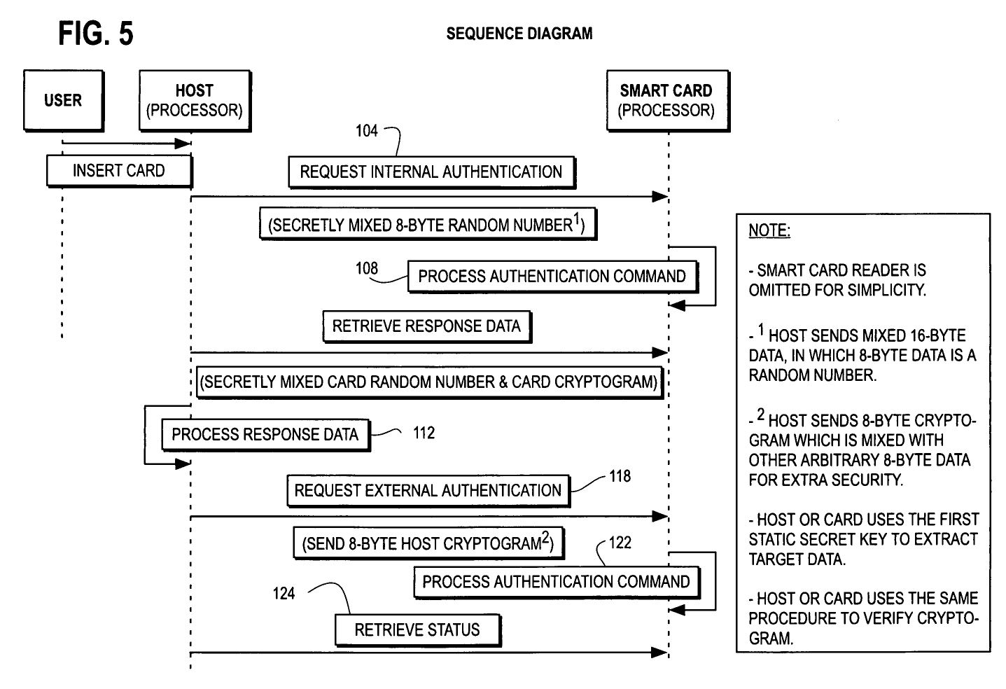

When retrieved by the host, FIG. 3, see step 112a, the random number and cryptogram are extracted using the first static key. The cryptogram is calculated using the second static key and compared to the received card cryptogram in step 112b.

Where the two cryptograms match external authentication is undertaken. The smart card processor receives the external authentication command which includes the host cryptogram step 122a. The smart card processor 30 calculates a cryptogram using the second static key for comparison with the host cryptogram, step 122b. Where the two cryptograms do not match, a condition not satisfied indicium 122-2 is forwarded to the host processor 20. In the presence of a match, a no error status indicium is forwarded to the host processor 20, step 122-3 and the data is then made available. FIG. 5 is a sequence diagram which further illustrates varies aspects of the interaction between the host processor and the smart card processor.

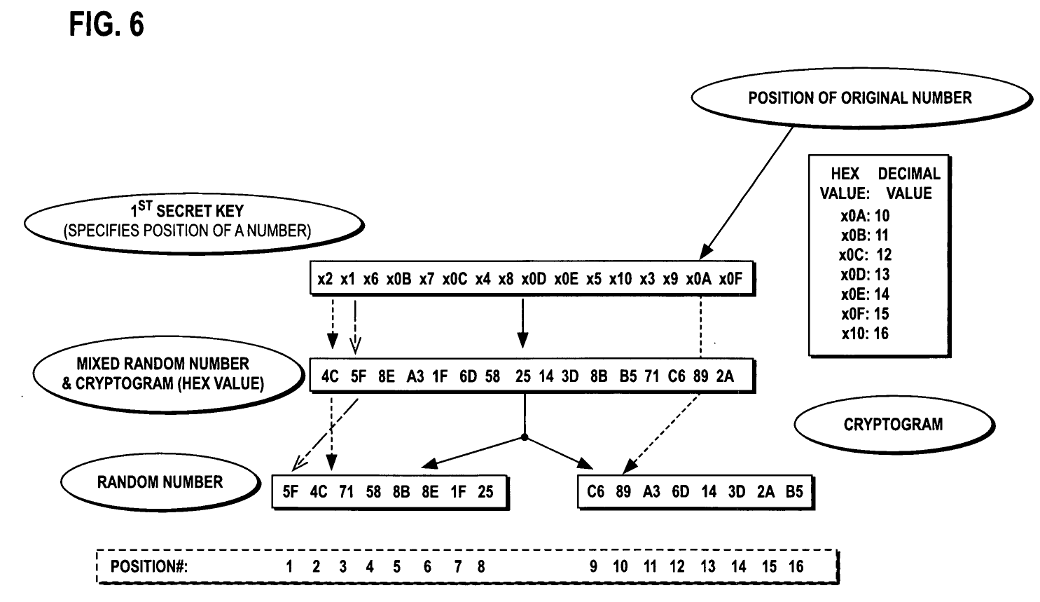

FIG. 6 illustrates additional details of the processing associated with the first static key which is used by both the smart card processor 30 and the serve or host processor 20. The first static key specifies the position of the target multi-byte number in a 16 byte random number received from the host for example which is to be used in the internal authentication process. The same static key is used by the smart card processor 30 to rearrange a card generated multi-byte random number and multi-byte cryptogram prior to sending it to the host processor. This key can also be used to extract a host generated cryptogram during external authentication.

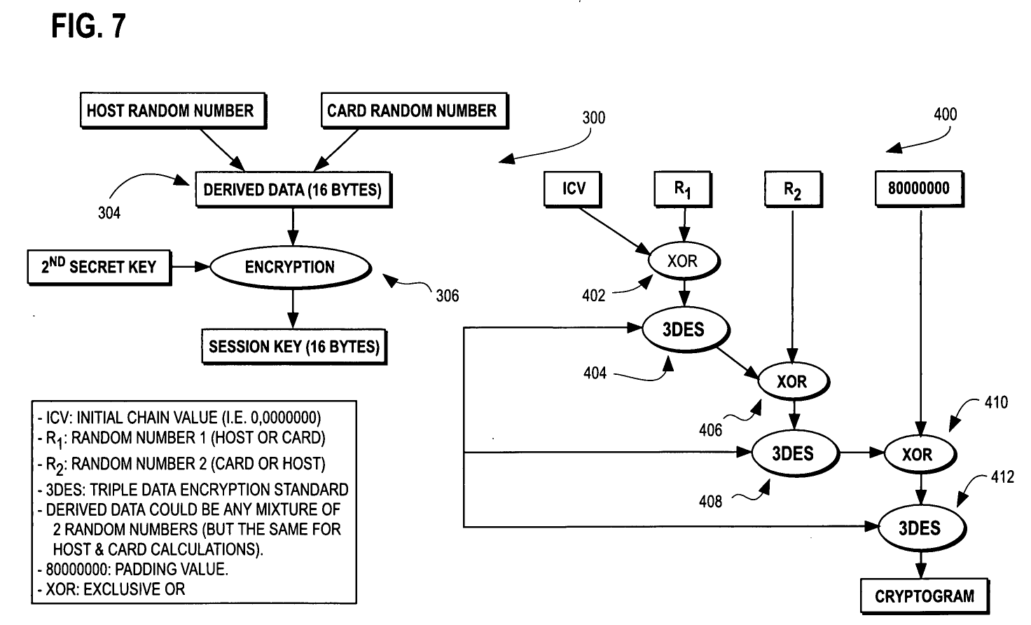

FIG. 7 illustrates smart card and host processing 300 associated with the second static key which is used by both the host and the smart card to generate a session key. The session key is determined from the same derived data, step 304 from host and smart card processor random numbers combined, step 306 with the same second static key. The session key is the same for both the host processor and the card processor. The session key is recalculated for each authentication process and it is different each time.

FIG. 7 also illustrates smart card and host processing 400 to determine a cryptogram. An initial value is exclusive-ored with the first random number, step 402. That result is processed with triple DES encryption step 404. That result and a second random number Rz are exclusive-ored, step 406, and triple encrypted again, step 408. Finally, that result is exclusive-ored with yet another selected value, step 410 and that result triple encrypted, step 410, to produce the cryptogram. It will be understood that neither the above sequence of steps nor the type of encryption are limitations of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
initiating a service request;
executing a first authentication process to establish the authenticity of a first, service requesting entity;
responsive to establishing the authenticity of the first entity, carrying out a second, authentication process between the first entity and a second entity;
responsive to the results of the second authentication process, providing information pre-stored at a first site to a second site in connection with providing the requested service.

2. A method as in claim 1 where the first authentication process includes establishing a mixed random number and encrypted information using a first predetermined key.

3. A method as in claim 2 where the second authentication process includes establishing encrypted information at the first site, using a second predetermined key.

4. A method as in claim 3 which includes comparing the established encrypted information to corresponding information received from the second site.

5. A method as in claim 3 which includes establishing a session key.

6. A method ass in claim 5 where a session key is established by each of the first entity and the second entity.

7. A method as in claim 6 where new session keys are established in carrying out an authentication process.

8. A method as in claim 6 where the session keys are identical.

9. A method as in claim 6 where the session keys are established at each entity using data common to both entities.

10. A method as in claim 1 which includes the second entity providing a first random number to the first entity in connection with carrying out the first authentication process.

11. A method as in claim 10 which includes combining a first key pre-established at the first entity with at least a portion of the first random number to establish a first response indicium.

12. A method as in claim 11 which includes providing the first response indicium to the second entity in carrying out the first authentication process.

13. A method as in claim 12 which includes receiving the first response indicium at the second entity and evaluating it to establish the authenticity of the first entity.

14. A method as in claim 13 which includes initiating the second authentication process at the first entity, including providing a first encrypted indicium.

15. A method as in claim 14 which includes processing the first encrypted indicium at the first entity to establish the authenticity of the second entity.

16. A method as in claim 15 which includes providing selected, unencrypted information, pre-stored at the first site, to the second site in response to establishing the authenticity of the first entity.

17. An apparatus comprising:
a first storage device;
selected data pre-loaded in unencrypted form into the first storage device;
first software executed local to the first storage device that establishes a local authentication indicium; and
second software executed local to the first storage device that transmits a representation of the authentication indicium to a displaced location.

18. An apparatus as in claim 17 which includes a body portion.

19. An apparatus as in claim 18 where the body portion carries at least the first storage device, as well as the first and second software.

20. An apparatus as in claim 17 which includes a programmable processor which executes the first and second software.

21. An apparatus as in claim 20 which includes third software that carries out an authentication process relative to another site.

22. An apparatus as in claim 21 which, responsive to a result of the authentication process, provides across to the selected data.

23. An apparatus as in claim 22 which includes a body portion and where the body portion carries at least the first storage device, and the processor.

24. A system comprising:
a first storage device;
selected data pre-loaded in unencrypted form into the first storage device;
first software executed local to the first storage device that establishes a local authentication indicium; and
second software executed local to the first storage device that transmits a representation of the authentication indicium to a displaced location;
third, displaced software that receives the representation of the authentication indicium and evaluates same; and
fourth, displaced software responsive to the evaluation by the third software, for carrying out a second authentication process.

25. A system as in claim 24 where the first software and the second software are carried by a body separate from the third and fourth software.
